(19) United States
(12) Patent Application Publication
(10) Pub. No.: US 2016/0275552 A1
(43) Pub. Date: Sep. 22, 2016

(54) SYSTEM AND METHOD FOR ENHANCED MULTI-CHANNEL, MULTI-OPTION, HIGHLY TARGETED AUTOMATED CAMPAIGNS

(71) Applicant: Swrve New Media, Inc., San Francisco, CA (US)

(72) Inventors: Hugh Reynolds, Walnut Creek, CA (US); Steve Collins, Dun Laoghaire (IE); Sean Handel, Moss Beach, CA (US); Christopher Dean, San Francisco, CA (US)

(21) Appl. No.: 15/072,068

(22) Filed: Mar. 16, 2016

Related U.S. Application Data
(63) Continuation of application No. 15/071,993, filed on Mar. 16, 2016.
Application No. 15/071,993 is a continuation of application No. 15/071,204, filed on Mar. 16, 2016.
Application No. 15/071,204 is a continuation-in-part of application No. 15/071,155, filed on Mar. 15, 2016.
(60) Provisional application No. 62/134,581, filed on Mar. 18, 2015.
(60) Provisional application No. 62/134,571, filed on Mar. 18, 2015.
(60) Provisional application No. 62/134,566, filed on Mar. 17, 2015.
(60) Provisional application No. 62/133,989, filed on Mar. 16, 2015.

(51) Int. Cl. G06Q 30/02

(52) U.S. Cl. CPC G06Q 30/0254; G06Q 30/0243

(57) ABSTRACT

A system for enhanced multi-channel, multi-option, highly targeted automated campaigns, comprising an application server that receives events via a network and provides them to an event load balancer that directs the operation of a plurality of event sinks each configured to receive events and perform event processing comprising at least a sorting process to determine a subset of events to be used for a content campaign, and a relay service configured to present content to a client device based at least in part on at least a portion of the events.

### CROSS-REFERENCE TO RELATED APPLICATIONS

This application claims the benefit of, and priority to, U.S. provisional patent application Ser. No. 62/134,581, titled “SYSTEM AND METHOD FOR ENHANCED MULTI-CHANNEL, MULTI-OPTION, HIGHLY TARGETED AUTOMATED CAMPAIGNS” and filed on Mar. 18, 2015. This application is also a continuation of U.S. patent application Ser. No. 15/071,993, titled “SYSTEM AND METHOD FOR SELF-OPTIMIZING, MULTI-CHANNEL, HIGHLY TARGETED, AUTOMATED CAMPAIGNS” and filed on Mar. 16, 2016, which claims the benefit of, and priority to, U.S. provisional patent application Ser. No. 62/134,571, titled “SYSTEM AND METHOD FOR SELF-OPTIMIZING, MULTI CHANNEL, HIGHLY TARGETED, AUTOMATED CAMPAIGNS”, filed on Mar. 18, 2015, which is a continuation of co-pending U.S. patent application Ser. No. 15/071,204, titled “SYSTEM AND METHOD FOR ENHANCED MULTI-CHANNEL, MULTI-OPTION, HIGHLY TARGETED AUTOMATED CAMPAIGNS” and filed on Mar. 16, 2016, which claims the benefit of, and priority to, U.S. provisional patent application Ser. No. 62/134,566, titled “SYSTEM AND METHOD FOR ENHANCED MULTI-CHANNEL, MULTI-OPTION, HIGHLY TARGETED AUTOMATED CAMPAIGNS”, filed on Mar. 17, 2015, which is a continuation-in-part of co-pending U.S. patent application Ser. No. 15/071,155 titled “SYSTEM AND METHOD FOR ENHANCED MULTI-CHANNEL, MULTI-OPTION, HIGHLY TARGETED AUTOMATED CAMPAIGNS” and filed on Mar. 15, 2016, which claims the benefit of, and priority to, U.S. provisional patent application Ser. No. 62/133,989, titled “SYSTEM AND METHOD FOR SELF-OPTIMIZING, MULTI CHANNEL, HIGHLY TARGETED, AUTOMATED CAMPAIGNS” and filed on Mar. 16, 2015, the entire specifications of each of which are incorporated herein by reference in their entirety.

### BACKGROUND OF THE INVENTION

1. Field of the Art

The disclosure relates to the field of marketing, and more particularly to the field of automatically conducting targeted marketing campaigns.

2. Discussion of the State of the Art

Today people are inundated by a barrage of digital offerings, some of which may be somewhat useful; but, most of them are less useful because they don't fit a target consumer's needs, demographically and contextually. As a result, the user perceives the message as “spam.”

What is needed is a different approach: one that, rather than feeling like spam to the user, makes offers that feel serendipitous. By making relevant offers in a contextually more meaningful way, less quantity and more quality can help improve the results with the customer for digital campaigns. Success isn't about building great apps, or even acquiring millions of users. It's about nurturing relationships with those users, that is, ensuring that as many installs as possible become engaged customers, as many engaged customers are retained, and engaged users become paying users.

What is further needed is a system and method to automatically segment the audience or customers of a system or app, and to automatically refine offerings, based on past experience and context of the user's current location, time of day, and weather situation, as well as other pertinent and obtainable information, for example based on speed and direction of movement in conjunction with location, with such a system enabling a marketing campaign to draw the user's attention to specific, limited time offerings.

### SUMMARY OF THE INVENTION

Accordingly, the inventor has conceived and reduced to practice, in a preferred embodiment of the invention, a system and method for enhanced, multi-channel, multi-option, highly targeted automated campaigns.

According to a preferred embodiment of the invention, a system for enhanced multi-channel, multi-option, highly targeted automated campaigns, comprising an application server comprising at least a plurality of programming instructions stored in a memory and operating on a processor of a network-connected computing device and configured to receive interaction from at least a client device via a network, the interaction comprising at least a plurality of events each comprising packet-based electronic data, and configured to provide at least a portion of the events to an event load balancer; an event load balancer comprising at least a plurality of programming instructions stored in a memory and operating on a processor of a network-connected computing device and configured to receive a plurality of events from at least an application server, and configured to direct the operation of a plurality of event sinks; an event sink comprising at least a plurality of programming instructions stored in a memory and operating on a processor of a network-connected computing device and configured to receive a plurality of events from an event load balancer, and configured to process at least a portion of the events, the processing comprising at least a sorting process to determine a subset of events to be used for a content campaign; and a relay service comprising at least a plurality of programming instructions stored in a memory and operating on a processor of a network-connected computing device and configured to receive a plurality of processed events from at least an event sink, and configured to present content to a client device based at least in part on at least a portion of the received events, is disclosed.

According to a further embodiment of the invention, a method for enhanced multi-channel, multi-option, highly targeted automated campaigns, comprising the steps of receiving, at an event load balancer comprising at least a plurality of programming instructions stored in a memory and operating on a processor of a network-connected computing device and configured to receive a plurality of events from at least an application server, and configured to direct the operation of a plurality of event sinks, a plurality of events; processing at least a portion of the events via an event sink comprising at least a plurality of programming instructions stored in a memory and operating on a processor of a network-connected computing device and configured to receive a plurality of events from an event load balancer, and configured to process at least a portion of the events, the processing comprising at least a sorting process to determine a subset of events to be used for further processing; and presenting, using a relay service comprising at least a plurality of programming instructions stored in a memory and operating on a processor of a network-connected computing device and configured to receive a plurality of processed events from at least an event sink, and configured to present content to a client device based at least in part on at least a portion of the received events, content to a client device based at least in part on the event processing, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in various embodiments of the invention.

FIG. 2 shows an overview of an exemplary system according to an embodiment of the invention.

FIG. 3 shows an overview diagram of exemplary system architecture for conducting enhanced, multi-channel, multi-option, highly targeted automated campaigns, according to a preferred embodiment of the invention.

FIG. 4 shows an exemplary set of multiple segments and subsegments, according to an embodiment of the invention.

FIG. 5 shows an exemplary screen for creating a new marketing campaign, according to an embodiment of the invention.

FIG. 6 is another block diagram illustrating an exemplary hardware architecture of a computing device used in an embodiment of the invention.

FIG. 7 is a block diagram illustrating an exemplary logical architecture for a client device, according to an embodiment of the invention.

FIG. 8 is a block diagram showing an exemplary architectural arrangement of clients, servers, and external services, according to an embodiment of the invention.

### DETAILED DESCRIPTION

The inventor has conceived, and reduced to practice, in a preferred embodiment of the invention, a system and method for enhanced, multi-channel, multi-option, highly targeted automated campaigns.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

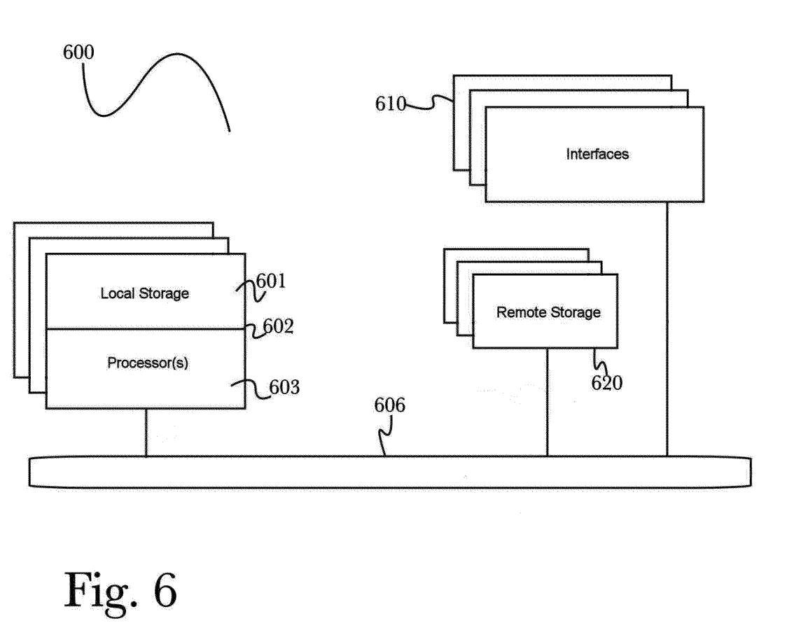

Referring now to FIG. 6, there is shown a block diagram depicting an exemplary computing device 600 suitable for implementing at least a portion of the features or functionalities disclosed herein. Computing device 600 may be, for example, any one of the computing machines listed in the previous paragraph, or indeed any other electronic device capable of executing software- or hardware-based instructions according to one or more programs stored in memory. Computing device 600 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 600 includes one or more central processing units (CPU) 602, one or more interfaces 610, and one or more busses 606 (such as a peripheral component interconnect (PCI) bus). When acting under the control of appropriate software or firmware, CPU 602 may be responsible for implementing specific functions associated with the functions of a specifically configured computing device or machine. For example, in at least one embodiment, a computing device 600 may be configured or designed to function as a server system utilizing CPU 602, local memory 601 and/or remote memory 620, and interface(s) 610. In at least one embodiment, CPU 602 may be caused to perform one or more of the different types of functions and/or operations under the control of software modules or components, which for example, may include an operating system and any appropriate applications software, drivers, and the like.

CPU 602 may include one or more processors 603 such as, for example, a processor from one of the Intel, ARM, Qualcomm, and AMD families of microprocessors. In some embodiments, processors 603 may include specially designed hardware such as application-specific integrated circuits (ASICs), electrically erasable programmable read-only memories (EEPROMs), field-programmable gate arrays (FPGAs), and so forth, for controlling operations of computing device 600. In a specific embodiment, a local memory 601 (such as non-volatile random access memory (RAM) and/or read-only memory (ROM), including for example one or more levels of cached memory) may also form part of CPU 602. However, there are many different ways in which memory may be coupled to system 600. Memory 601 may be used for a variety of purposes such as, for example, caching and/or storing data, programming instructions, and the like. It should be further appreciated that CPU 602 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 610 are provided as network interface cards (NICs). Generally, NICs control the sending and receiving of data packets over a computer network; other types of interfaces 610 may for example support other peripherals used with computing device 600. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 610 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 6 illustrates one specific architecture for a computing device 600 for implementing one or more of the inventions described herein, it is by no means the only device architecture on which at least a portion of the features and techniques described herein may be implemented. For example, architectures having one or any number of processors 603 may be used, and such processors 603 may be present in a single device or distributed among any number of devices. In one embodiment, a single processor 603 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 620 and local memory 601) configured to store data, program instructions for the general-purpose network operations, or other information relating to the functionality of the embodiments described herein (or any combinations of the above). Program instructions may control execution of or comprise an operating system and/or one or more applications, for example. Memory 620 or memories 601, 620 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

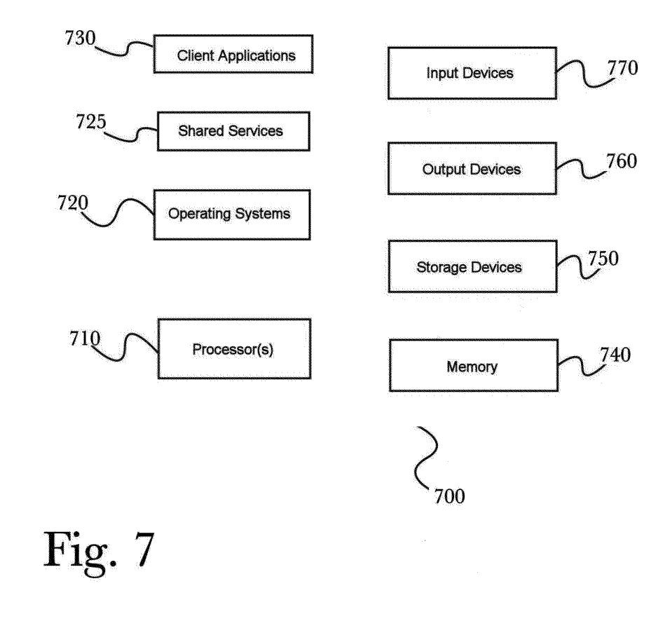

In some embodiments, systems according to the present invention may be implemented on a standalone computing system. Referring now to FIG. 7, there is shown a block diagram depicting a typical exemplary architecture of one or more embodiments or components thereof on a standalone computing system. Computing device 700 includes processors 710 that may run software that carry out one or more functions or applications of embodiments of the invention, such as for example a client application 730. Processors 710 may carry out computing instructions under control of an operating system 720 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 725 may be operable in system 700, and may be useful for providing common services to client applications 730. Services 725 may for example be WINDOWS™ services, user-space common services in a Linux environment, or any other type of common service architecture used with operating system 710. Input devices 770 may be of any type suitable for receiving user input, including for example a keyboard, touchscreen, microphone (for example, for voice input), mouse, touchpad, trackball, or any combination thereof. Output devices 760 may be of any type suitable for providing output to one or more users, whether remote or local to system 700, and may include for example one or more screens for visual output, speakers, printers, or any combination thereof. Memory 740 may be random-access memory having any structure and architecture known in the art, for use by processors 710, for example to run software. Storage devices 750 may be any magnetic, optical, mechanical, memristor, or electrical storage device for storage of data in digital form (such as those described above, referring to FIG. 6). Examples of storage devices 750 include flash memory, magnetic hard drive, CD-ROM, and/or the like.

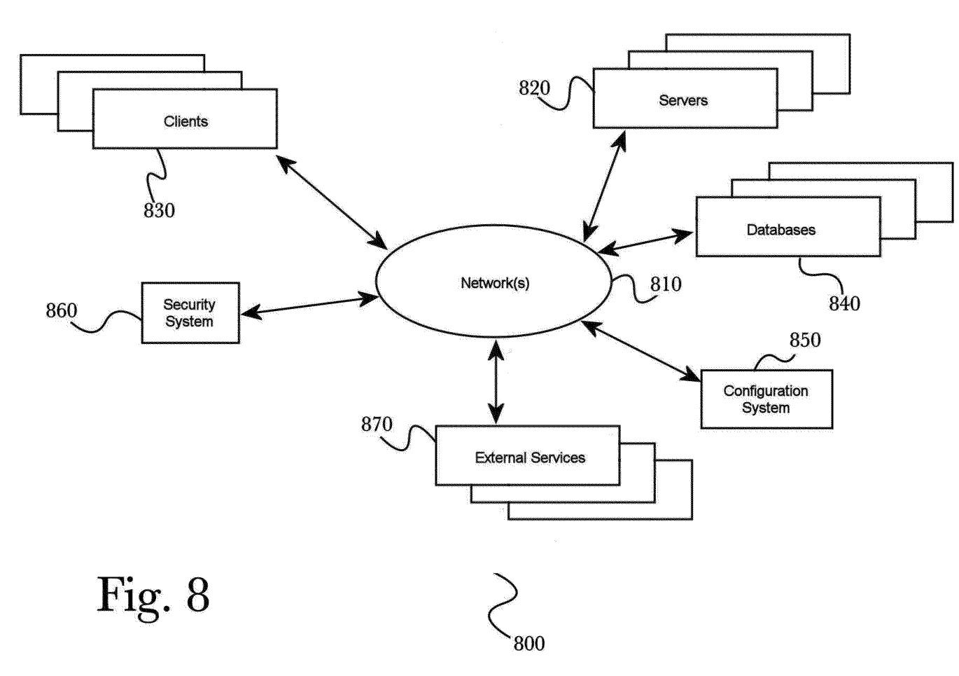

In some embodiments, systems of the present invention may be implemented on a distributed computing network, such as one having any number of clients and/or servers. Referring now to FIG. 8, there is shown a block diagram depicting an exemplary architecture 800 for implementing at least a portion of a system according to an embodiment of the invention on a distributed computing network. According to the embodiment, any number of clients 830 may be provided. Each client 830 may run software for implementing client-side portions of the present invention; clients may comprise a system 700 such as that illustrated in FIG. 7. In addition, any number of servers 820 may be provided for handling requests received from one or more clients 830. Clients 830 and servers 820 may communicate with one another via one or more electronic networks 810, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 810 may be implemented using any known network protocols, including for example wired and/or wireless protocols.

In addition, in some embodiments, servers 820 may call external services 870 when needed to obtain additional information, or to refer to additional data concerning a particular call. Communications with external services 870 may take place, for example, via one or more networks 810. In various embodiments, external services 870 may comprise web-enabled services or functionality related to or installed on the hardware device itself. For example, in an embodiment where client applications 730 are implemented on a smartphone or other electronic device, client applications 730 may obtain information stored in a server system 820 in the cloud or on an external service 870 deployed on one or more of a particular enterprise's or user's premises.

In some embodiments of the invention, clients 830 or servers 820 (or both) may make use of one or more specialized services or appliances that may be deployed locally or remotely across one or more networks 810. For example, one or more databases 840 may be used or referred to by one or more embodiments of the invention. It should be understood by one having ordinary skill in the art that databases 840 may be arranged in a wide variety of architectures and using a wide variety of data access and manipulation means. For example, in various embodiments one or more databases 840 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 860 and configuration systems 850. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 860 or configuration system 850 or approach is specifically required by the description of any specific embodiment.

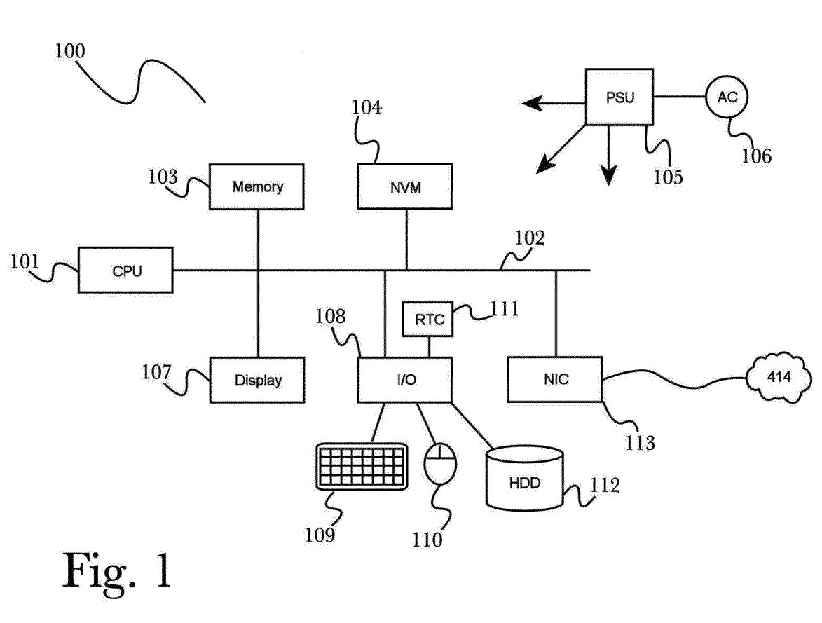

FIG. 1 shows an exemplary overview of a computer system 100 as may be used in any of the various locations throughout the system. It is exemplary of any computer that may execute code to process data. Various modifications and changes may be made to computer system 100 without departing from the broader scope of the system and method disclosed herein. Central processor unit (CPU) 101 is connected to bus 102, to which bus is also connected memory 103, nonvolatile memory 104, display 107, input/output (I/O) unit 108, and network interface card (NIC) 113. I/O unit 108 may, typically, be connected to keyboard 109, pointing device 110, hard disk 112, and real-time clock 111. NIC 113 connects to network 114, which may be the Internet or a local network, which local network may or may not have connections to the Internet. Also shown as part of system 100 is power supply unit 105 connected, in this example, to a main alternating current (AC) supply 106. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

In some cases, a system for multi-option, multi-channel marketing messaging may enable marketing partners to integrate their web services easily, using a simple interface so a marketing person is able to configure a complex, multi-channel multi-option campaign with options adjusted automatically in near real time according to the responses or non-responses provided by the target audience. Such a system may prefer mobile devices as a target of campaigns, obtaining position information from each targeted user's device and using local context information to refine the offer. This local context information may include data such as nearby businesses and competitors, time of day, day of the week, locally applicable holidays, and local weather information. Further, omnichannel marketing using user context available from a mobile device may be used to further segment the campaign audience and personalize the message. Optimization of those campaigns may be achieved through means such as traditional multivariate testing, and further auto-discovery of subsegments of the audience is used where a local optimization is possible. Additionally, message types and delivery channels may include in-app messaging, push notifications, emails, ads, web site, and any other similar, suitable messaging option, with the system auto-optimizing the delivery channel of the message based on testing. The system then may also take into account all the optimizations and subsegments above and then automatically design future campaigns using this data to increase effectiveness.

In some other cases, a system for multi-option, multi-channel marketing messaging may enable marketing partners to integrate their web services easily, using a simple interface so a marketing person is able to configure a complex, multi-channel multi-option campaign with options adjusted automatically in near real time according to the responses or non-responses provided by the target audience. The system may also offer multiple options to each demographic subsegment of users in a randomized way, and then, based on a preference of a demographic subsegment for one option, the system may store this preference, in conjunction with all other local contextual data, for future use. Further, omnichannel marketing using user context available from a mobile device may be used to further segment the campaign audience and personalize the message. Optimization of those campaigns may be achieved through means such as traditional multivariate testing, and further auto-discovery of subsegments of the audience is used where a local optimization is possible. Additionally, message types and delivery channels may include in-app messaging, push notifications, emails, ads, web site, and any other similar, suitable messaging option, with the system auto-optimizing the delivery channel of the message based on testing. The system then may also take into account all the optimizations and subsegments above and then automatically design future campaigns using this data to increase effectiveness.

In further cases, a system for multi-option, multi-channel marketing messaging may enable marketing partners to integrate their web services easily, using a simple interface so a marketing person is able to configure a complex, multi-channel multi-option campaign with options adjusted automatically in near real time according to the responses or non-responses provided by the target audience. The system may also offer multiple options to each demographic subsegment of users in a randomized way, with each user receiving different options, depending on time of day and channel used. Delivery channels may include in-application messaging, emails, and other third-party apps having messaging capabilities. The system, additionally, may detect a preferred mode of response, based on factors such as, for example, location, time of day, demographic subsegment, weather, etc., and may store preferred response mode for future use. Further, omnichannel marketing using user context available from a mobile device may be used to further segment the campaign audience and personalize the message. Optimization of those campaigns may be achieved through means such as traditional multivariate testing, and further auto-discovery of subsegments of the audience is used where a local optimization is possible. Additionally, message types and delivery channels may include in-app messaging, push notifications, emails, ads, web site, and any other similar, suitable messaging option, with the system auto-optimizing the delivery channel of the message based on testing. The system then may also take into account all the optimizations and subsegments above and then automatically design future campaigns using this data to increase effectiveness.

In yet additional cases, a system for multi-option, multi-channel marketing messaging may enable marketing partners to integrate their web services easily, using a simple interface so a marketing person is able to configure a complex, multi-channel multi-option campaign with options adjusted automatically in near real time according to the responses or non-responses provided by the target audience. Based on past responses, the system may then target new campaigns to the most successful mode of the past, with several long-term aspects included relating to fashioning new campaigns, such aspects including time of year, taking into account corresponding changes in responsiveness to prior campaign modes and modifications. Further, omnichannel marketing using user context available from a mobile device may be used to further segment the campaign audience and personalize the message. Optimization of those campaigns may be achieved through means such as traditional multivariate testing, and further auto-discovery of subsegments of the audience is used where a local optimization is possible. Additionally, message types and delivery channels may include in-app messaging, push notifications, emails, ads, web site, and any other similar, suitable messaging option, with the system auto-optimizing the delivery channel of the message based on testing. The system then may also take into account all the optimizations and subsegments above and then automatically design future campaigns using this data to increase effectiveness.

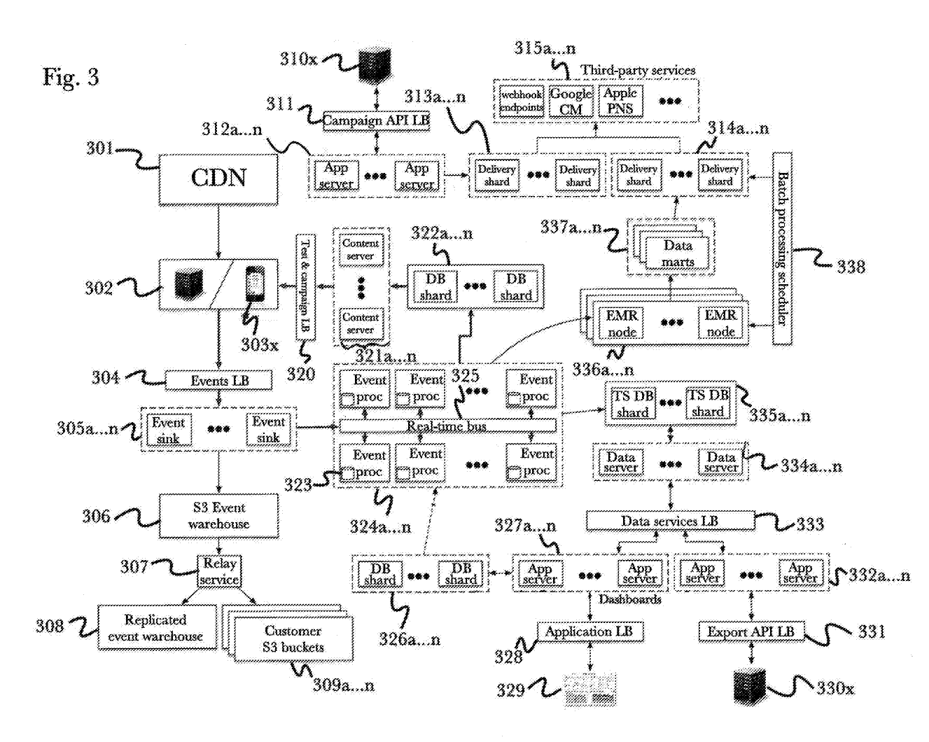

FIG. 3 shows an overview diagram of exemplary system architecture 300, according to a preferred embodiment of the invention. Content delivery network 301 connects to application server 302 and user device 303x. Events are recorded in event load balancer 304. In event sinks 305a-n events are filtered and sorted. Events then proceed to event warehouse 306 and further to relay service 307. The move from warehouse 306 to relay service 307 may be triggered when conditions set in the marketing campaign, for example being across the street or less than 100 feet from a participating coffee shop, are met. These conditions are set up by the customer. They may use location services on a mobile device, for example; or it may be a slow time in the afternoon, and low cash register activity may cause a trigger to drum up nearby customers with a discount, for example. The process then moves to replicated event warehouse 308 or customer buckets 309a-n that are on a cloud service such as, for example, Amazon S3™, and contain customer-specific content to be delivered for those events. The delivery goes upward again to user device 303x. Device 303x is also connected via A/B test and campaign load balancer 320 to content servers 321a-n and user state database with shared attributes 322a-n. Event processing system 323 uses a shared real-time bus 325 to share messages among event processors 324a-n. These processors could be, for example, cloud instances on the computing cloud, and they may be added as needed for load balancing. System control application (SCA) 329, which enables a customer to configure campaigns, etc., connects through application load balancer 328 into the app servers 327a-n. Business intelligence server 330x connects through export API 331 to app servers 332a-n and uses that connection to interact with the system. Both server banks 327a-n and 332a-n can access shared data repositories 326a-n. Data services are combined in load balancer 333 and sent to data servers 334a-n, and from there on to time series shared databases 335a-n, all connecting to event processor bank 323. Bank 323 also interfaces to user record processor arrays 336aa-nn. Each customer has its own bank, with each bank containing multiple servers, so the entire installation may be considered an array. Arrays 336aa-nn connect to data marts 337a-n, which in turn connect to delivery shards 314a-n. Delivery shards 313a-n receive applications from campaign API servers 312a-n, which are connected to campaign API load balancer 311, which in turn connects to customer CRM server 310x. Delivery shards 313a-n and 314a-n connect to third-party services such as, for example, other applications, Google, Apple, etc., for various messaging services and integration.

### DETAILED DESCRIPTION OF EXEMPLARY EMBODIMENTS

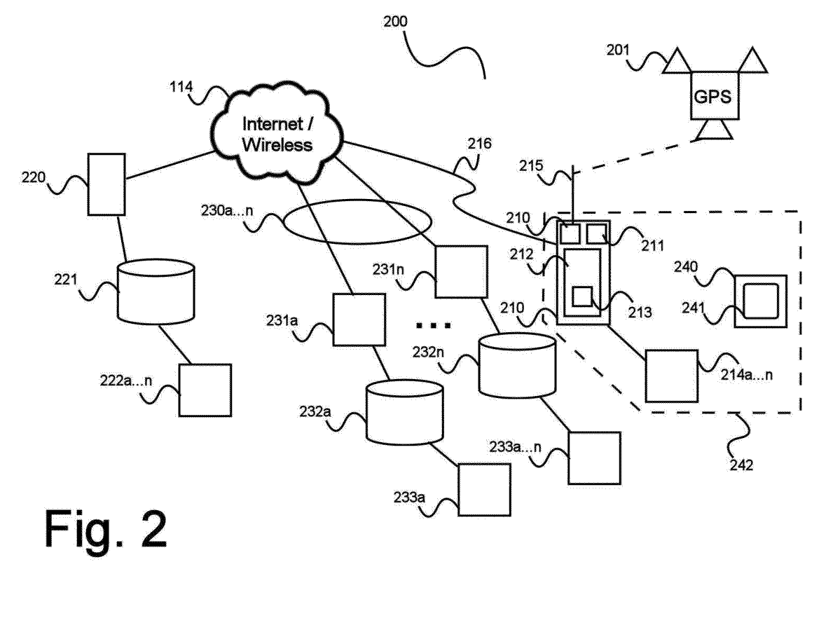

FIG. 2 shows an overview of an exemplary system 200, as currently typically used for so-called “cloud-based” systems, but similar to what may be referred to as client-server systems. The wireless Internet 114 is configured, for the purposes of the system and method disclosed herein, as one conglomerate network, even though it is clear that multiple carriers and other wireless LANs may be offered. An operating center has a server 220 with mass storage 221 and programs 222a-n that are used to provide the service of the system and method disclosed herein, which service is described later and throughout. Note that server 220 has a structure similar to the computer discussed in FIG. 1. Multiple systems of servers at participating partners and or user devices at those partners' locations are connected to the Internet via connections 230a-n. Each server or computing device has its own web service system 231a-n (in some cases, they may have their own web infrastructure; in other cases, they may use cloud-based services, etc., which may appear as virtual servers), enabling a so-called Software as a Service (SaaS) delivery. Servers 213a-n may have a structure similar to the computer discussed in FIG. 1. Each web service system 231 (whether real or virtual) has its own storage 232a-n and its own sets of software 232aa-an through 232na-nn. Also shown is a user with a device 210, which device could be a smart phone with a structure similar to the computing device discussed in FIG. 1. Device 210 contains, in this example, software 214a-n, a camera 211, and in some cases a GPS 215 chip that communicates with GPS satellites 250a-n. Software 214x may be machine-readable code that is stored on a storage media, or downloadable over a network connection, and installed on a mobile computing device 210. The user in the field, for example at his home, at his office, in a testing lab, or anywhere else uses device 210 to interact with the servers delivering the content as a web service, typically using one or more of the servers described herein. The user clicks on application 213 contained in device 210 and follows the instructions that appear on the screen, thus pulling up additional data from the server as discussed further herein. Further, it shall be deemed equivalent if, for example, instead of so-called on premise servers and or cloud services, a third-party service is used for hosting said services

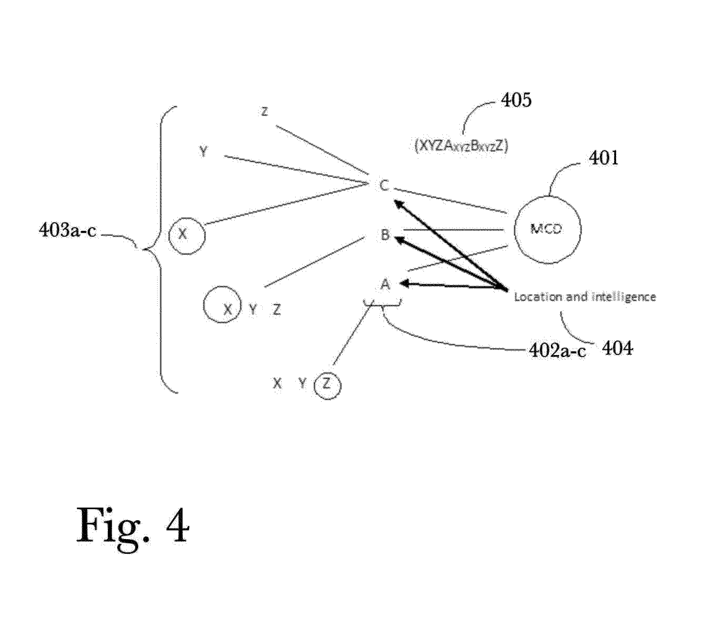

FIG. 4 shows an exemplary set 400 of multiple segments and subsegments, according to an embodiment of the invention. Location and intelligence information, based on the user's location, may be later added into the various segments such as, for example, segments A, B, and C402a-c. Each segment has a demographic subsegment, such as, for example, subsegments X, Y, Z403a-c. In this example, for segment C the successful subsegment is X, for segment B the successful subsegment is also X, while for segment A the successful subsegment is Z A successful subsegment, having a large conversion rate of offers, such as Z in this example, may be, for example, offering a coffee in the morning or in the afternoon, offering a hot beverage on a cold day, offering a cold beverage on a hot day, etc. Thus the system calculates which combination(s) of subsegments and segments (with all location and intelligence 404) work, and how well they work. Based on the resulting data, the system is able to refine and automatically learn successful subsegment combinations. Expression 405 symbolizes a combination of segments and subsegments as it may be expressed in the system to identify a successful combination. It then stores these results in the marketing campaign database MCD 401, including data such as location, weather, time of day, time of year, holiday, weekend, business day, etc.

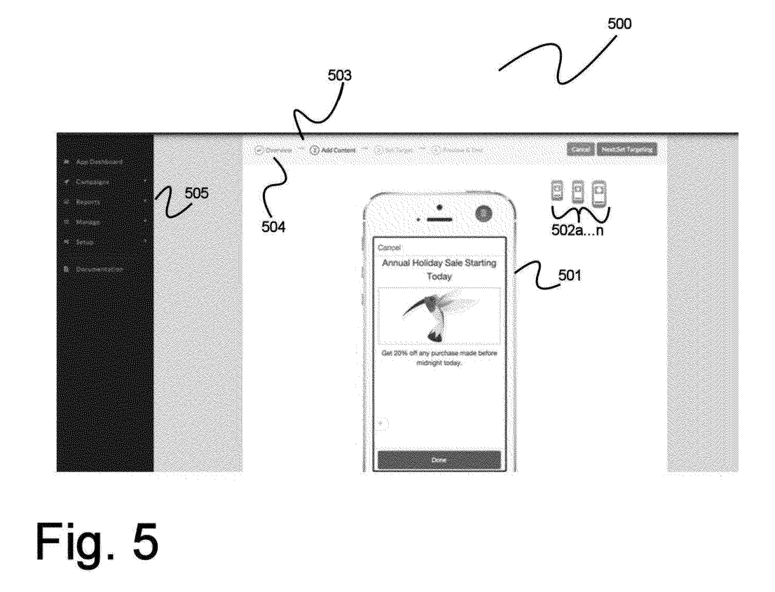

FIG. 5 shows an exemplary screen 500 for creating a new marketing campaign, according to an embodiment of the invention. Device 501 has been selected from a variety of devices 502a-n offered to the user. This selection may be highly targeted to specific hardware, or simply based on specifications such as screen size, etc. Toolbar 503 contains several choices, including the currently displayed overview option 504, whose selection is indicated by a check mark. Sequential options include, in this example, Add Content, Set Target, Preview & Test. On the far left is vertical navigation bar 504, wherein the user can select among application functions, such as, in this example, viewing the dashboard, creating and managing campaigns, generating and viewing reports, managing application resources and user segment definitions, and setting up the account.

Various embodiments of the present disclosure may be implemented in computer hardware, firmware, software, and/or combinations thereof. Methods of the present disclosure can be implemented via a computer program instructions stored on one or more non-transitory computer-readable storage devices for execution by a processor. Likewise, various processes (or portions thereof) of the present disclosure can be performed by a processor executing computer program instructions. Embodiments of the present disclosure may be implemented via one or more computer programs that are executable on a computer system including at least one processor coupled to receive data and instructions from, and to transmit data and instructions to, a data storage system, at least one input device, and at least one output device. Each computer program can be implemented in any suitable manner, including via a high-level procedural or object-oriented programming language and/or via assembly or machine language. Systems of the present disclosure may include, by way of example, both general and special purpose microprocessors which may retrieve instructions and data to and from various types of volatile and/or non-volatile memory. Computer systems operating in conjunction with the embodiments of the present disclosure may include one or more mass storage devices for storing data files, which may include: magnetic disks, such as internal hard disks and removable disks; magneto-optical disks; and optical disks. Storage devices suitable for tangibly embodying computer program instructions and data (also called the “non-transitory computer-readable storage media”) include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

In some cases, a system for multi-option, multi-channel marketing messaging may enable marketing partners to integrate their web services easily, using a simple interface so a marketing person is able to configure a complex, multi-channel multi-option campaign with options adjusted automatically in near real time according to the responses or non-responses provided by the target audience. Such a system may prefer mobile devices as a target of campaigns, obtaining position information from each targeted user's device and using local context information to refine the offer. This local context information may include data such as nearby businesses and competitors, time of day, day of the week, locally applicable holidays, and local weather information. Further, omnichannel marketing using user context available from a mobile device may be used to further segment the campaign audience and personalize the message. Optimization of those campaigns may be achieved through means such as traditional multivariate testing, and further auto-discovery of subsegments of the audience is used where a local optimization is possible. Additionally, message types and delivery channels may include in-app messaging, push notifications, emails, ads, web site, and any other similar, suitable messaging option, with the system auto-optimizing the delivery channel of the message based on testing. The system then may also take into account all the optimizations and subsegments above and then automatically design future campaigns using this data to increase effectiveness.

In some other cases, a system for multi-option, multi-channel marketing messaging may enable marketing partners to integrate their web services easily, using a simple interface so a marketing person is able to configure a complex, multi-channel multi-option campaign with options adjusted automatically in near real time according to the responses or non-responses provided by the target audience. The system may also offer multiple options to each demographic subsegment of users in a randomized way, and then, based on a preference of a demographic subsegment for one option, the system may store this preference, in conjunction with all other local contextual data, for future use. Further, omnichannel marketing using user context available from a mobile device may be used to further segment the campaign audience and personalize the message. Optimization of those campaigns may be achieved through means such as traditional multivariate testing, and further auto-discovery of subsegments of the audience is used where a local optimization is possible. Additionally, message types and delivery channels may include in-app messaging, push notifications, emails, ads, web site, and any other similar, suitable messaging option, with the system auto-optimizing the delivery channel of the message based on testing. The system then may also take into account all the optimizations and subsegments above and then automatically design future campaigns using this data to increase effectiveness.

In further cases, a system for multi-option, multi-channel marketing messaging may enable marketing partners to integrate their web services easily, using a simple interface so a marketing person is able to configure a complex, multi-channel multi-option campaign with options adjusted automatically in near real time according to the responses or non-responses provided by the target audience. The system may also offer multiple options to each demographic subsegment of users in a randomized way, with each user receiving different options, depending on time of day and channel used. Delivery channels may include in-application messaging, emails, and other third-party apps having messaging capabilities. The system, additionally, may detect a preferred mode of response, based on factors such as, for example, location, time of day, demographic subsegment, weather, etc., and may store preferred response mode for future use. Further, omnichannel marketing using user context available from a mobile device may be used to further segment the campaign audience and personalize the message. Optimization of those campaigns may be achieved through means such as traditional multivariate testing, and further auto-discovery of subsegments of the audience is used where a local optimization is possible. Additionally, message types and delivery channels may include in-app messaging, push notifications, emails, ads, web site, and any other similar, suitable messaging option, with the system auto-optimizing the delivery channel of the message based on testing. The system then may also take into account all the optimizations and subsegments above and then automatically design future campaigns using this data to increase effectiveness.

In yet additional cases, a system for multi-option, multi-channel marketing messaging may enable marketing partners to integrate their web services easily, using a simple interface so a marketing person is able to configure a complex, multi-channel multi-option campaign with options adjusted automatically in near real time according to the responses or non-responses provided by the target audience. Based on past responses, the system may then target new campaigns to the most successful mode of the past, with several long-term aspects included relating to fashioning new campaigns, such aspects including time of year, taking into account corresponding changes in responsiveness to prior campaign modes and modifications. Further, omnichannel marketing using user context available from a mobile device may be used to further segment the campaign audience and personalize the message. Optimization of those campaigns may be achieved through means such as traditional multivariate testing, and further auto-discovery of subsegments of the audience is used where a local optimization is possible. Additionally, message types and delivery channels may include in-app messaging, push notifications, emails, ads, web site, and any other similar, suitable messaging option, with the system auto-optimizing the delivery channel of the message based on testing. The system then may also take into account all the optimizations and subsegments above and then automatically design future campaigns using this data to increase effectiveness.

The skilled person will be aware of a range of possible modifications of the various embodiments described above. Accordingly, the present invention is defined by the claims and their equivalents.

What is claimed is:

1. A system for enhanced multi-channel, multi-option, highly targeted automated campaigns, comprising:
an application server comprising at least a plurality of programming instructions stored in a memory and operating on a processor of a network-connected computing device and configured to receive interaction from at least a client device via a network, the interaction comprising at least a plurality of events each comprising packet-based electronic data, and configured to provide at least a portion of the events to an event load balancer;
wherein the application server exposes an application programming interface via the Internet to allow marketing partners to integrate their web services with the application server;
wherein a simple user interface is provided by the application server to enable a remote user to configure a complex, multi-channel multi-option campaign, and
wherein a plurality of options are adjusted automatically by the application server, in near real time, based at least in part on responses or non-responses to the complex, multi-channel multi-option campaign, provided by a targeted audience.

2. The system of claim 1, wherein, based on past responses, new campaigns are targeted a most successful campaign mode of the past.

3. The system of claim 2, wherein several long-term aspects are included as to fashioning new campaigns, such aspects including time of year, and change in responsiveness to prior campaign modes and modifications accordingly.

4. The system of claim 3, wherein user context information received over the Internet from a mobile device is used by the application server to further segment the targeted audience and to personalize a message.

5. The system of claim 1, wherein the application server optimizes the complex, multi-channel multi-option campaign using multivariate testing.

6. The system of claim 5, wherein further auto-discovery of subsegments of the target audience is used where a local optimization is possible.

7. The system of claim 5, wherein message types/delivery channels to a user are drawn from a set including: in-application messaging, push notifications, emails, ads, web pages, and any other messaging option.

8. The system of claim 7, wherein further auto-optimizing a delivery channel of a message is based on testing.

9. The system of claim 8, wherein the application server takes into account all optimizations and subsegments used above and then automatically targets future campaigns using this data to increase effectiveness.
